(19) United States
(12) Patent Application Publication
(10) Pub. No.: US 2008/0066582 A1
(43) Pub. Date: Mar. 20, 2008

(54) HAMMER STRUCTURE

(76) Inventor: Yung-Shou Chen, Taichung Hsien (TW)

Correspondence Address: PAI PATENT & TRADEMARK LAW FIRM, 1001 FOURTH AVENUE, SUITE 3200, SEATTLE, WA, 98154, US

(21) Appl. No.: 11/533,477

(22) Filed: Sep. 20, 2006

(51) Int. Cl. B25D 1/00; B25D 11/00

(52) U.S. Cl. 81/20; 173/90

(57) ABSTRACT

A hammer structure with a hammerhead having an impact face with a shape of the letter “D” is disclosed. The impact face has three straight sides, and one arc-shaped side; as a result, the surface area of the impact face is substantially larger than that of a conventional O-shaped impact face with the same width and height. Since the effective impact face is enlarged, the point of force application can be more precisely controlled, regardless of whether the hammering is carried out on a single wall, a corner between two walls, or any similar locations. Moreover, the problems caused by dead spots can be overcome.

### BACKGROUND OF THE INVENTION

(a) Field of the Invention

The invention relates to a hammer structure. More particularly, the invention relates to a hammer structure having a hammerhead that has an impact face shaped like the letter “D”.

(b) Description of the Prior Art

In the prior art handheld hammers, the impact face 10 of the hammerhead is generally shaped as the letter “O”, hence when it comes into contact with a wall 20 or any vertical surface of similar locations, the vertical surface can only touch the top of the impact face as a tangent line (as shown in FIG. 6), and the area beyond the contact point of the tangent line is outside of the effective hammering action, while it is difficult to precisely control the point at which force is applied. Moreover, when the hammering actions are to be carried out on a corner 30 around the walls or any similar locations (as shown in FIG. 7), the “O”-shaped hammerhead can only come into contact with the walls via two tangent lines at most, but it can not reach the dead spot 40 between the two tangent lines and the “O”-shaped hammerhead, which remains beyond the reach of hammering actions. As a result, the two situations described above pose irresolvable problems to the users during hammering. In U.S. Pat. No. 4,433,709, a structure of hammer was disclosed, in which one end of the hammerhead is formed with a blade portion, and a small portion is removed from the top side of an impact face 50 of the hammerhead; by slicing a small portion off the “O”-shaped hammerhead, the top side of the “O”-shaped hammerhead becomes linear, which in turn makes the vertical diameter of the impact face shorter. Though this structure creates a linear edge on the top side of the hammerhead, which is suitable for hammering on a wall 20 or any similar locations because its top side can come into full contact with the vertical surface (as shown in FIG. 8), the original area of the “O”-shaped hammerhead is reduced significantly, which partially decreases the effective impact face 50 of the hammerhead, and this becomes a great disadvantage to the process of hammering actions. Furthermore, the structure only creates a linear edge on the top side of the hammerhead, the rest still remains arc-shaped, thus when carrying out hammering actions on a corner 60 between two walls or any similar locations, the contact between the hammerhead and the walls is still limited to tangent lines only, which still leave an area 70 (as shown in FIG. 9) beyond hammering actions, and thus the disadvantage remains unaddressed.

### SUMMARY OF THE INVENTION

The main objective of the invention is to provide a hammer structure, in which the impact face of its hammerhead has three straight sides and one arc-shaped side, wherein the three straight sides are perpendicular to one another, making the impact face to appear in the shape of a letter “D”. As a result, the effective impact area of the impact face is larger compared to that of a conventional O-shaped impact face, given the same width and height. Because the hammer structure provides three straight sides of its impact face, it allows users to more precisely control the point of force application when carrying out hammering actions on a single wall, a corner between two walls, or any other similar locations Moreover, any otherwise dead spots that may be encountered during hammering can be reached, thus allowing users to take full advantage of the functions of hammers.

### BRIEF DESCRIPTION OF THE DRAWINGS

FIG. 1 is a three-dimensional assembled view showing the hammer structure according to a preferred embodiment of the invention.

FIG. 2 is a front view of FIG. 1.

FIG. 3 is a schematic view showing the hammering action on the corner of a wall by using the hammer structure according to the preferred embodiment of the invention.

FIG. 4 is a schematic view showing the hammering action on a single wall by using the hammer structure according to the preferred embodiment of the invention.

FIG. 5 is a schematic view showing the hammering action on the corner of a wall by using the hammer structure according to the preferred embodiment of the invention.

FIG. 6 is a schematic view showing the hammering action on a single wall by using a prior art hammer structure.

FIG. 7 is a schematic view showing the hammering action on the corner of a wall by using the prior art hammer structure.

FIG. 8 is a schematic view showing the hammering action on a single wall by using another prior art hammer structure.

FIG. 9 is a schematic view showing the hammering action on the corner of a wall by using the prior art hammer structure similar to FIG. 8.

### DETAILED DESCRIPTION OF THE PREFERRED EMBODIMENTS

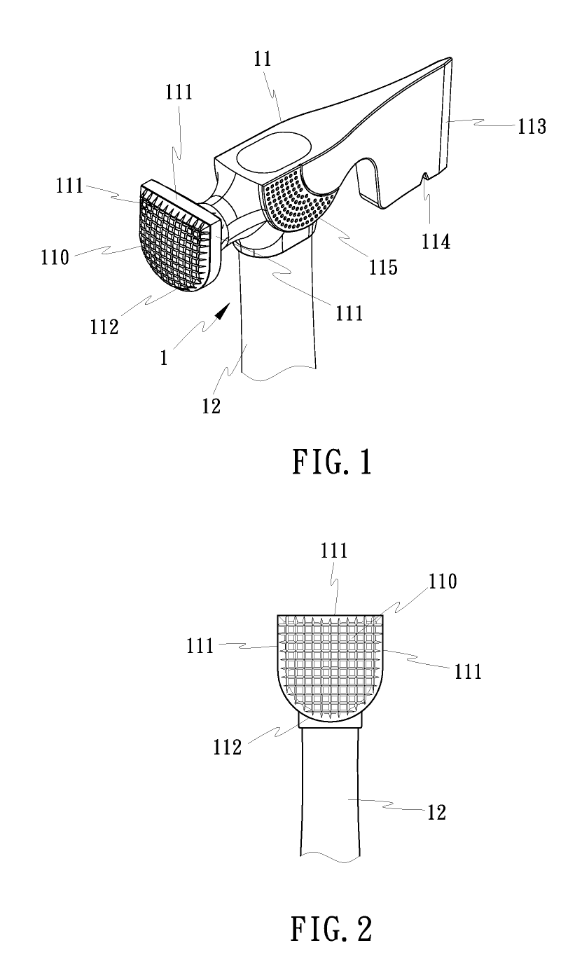

As shown in FIG. 1 and FIG. 2, the hammer structure according to a preferred embodiment of the invention is mainly a structure on a hammerhead 11 of a hammer 1. Particularly, an impact face 110 of said hammerhead 11 is formed with three straight sides 111 and one arc-shaped side 112. One of the three straight sides 111 is connected to and perpendicular to the other two straight sides, which are in turn connected to the arc-shaped side 112. Thus, the impact face 110 is formed roughly in the shape of a letter “D”. As a result, the surface area of the impact face 110 in said hammerhead is relatively larger than that of a conventional O-shaped impact face, given the same width and height.

Moreover, the impact face 110 may be made to have a rough surface.

According to the preferred embodiments shown in the figures, the three straight sides 111 are respectively located at the top side and two lateral sides of the hammerhead 11, while the arc-shaped side 112 is the bottom side. Here the top side refers to the side which is farthest from the free end of a handle when the handle is attached to the hammerhead.

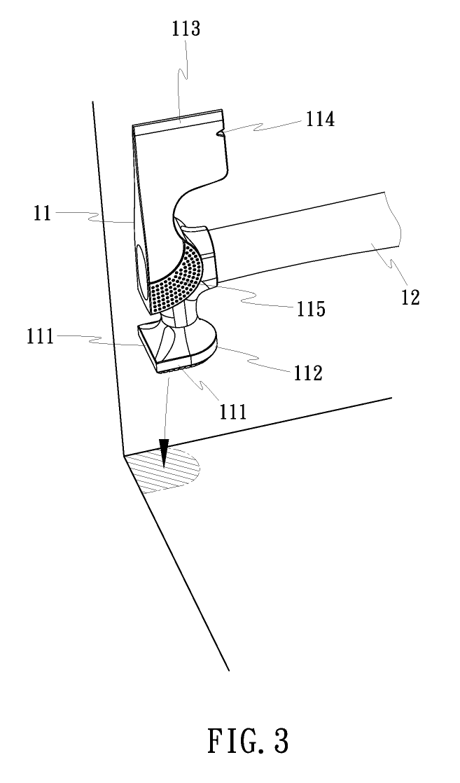

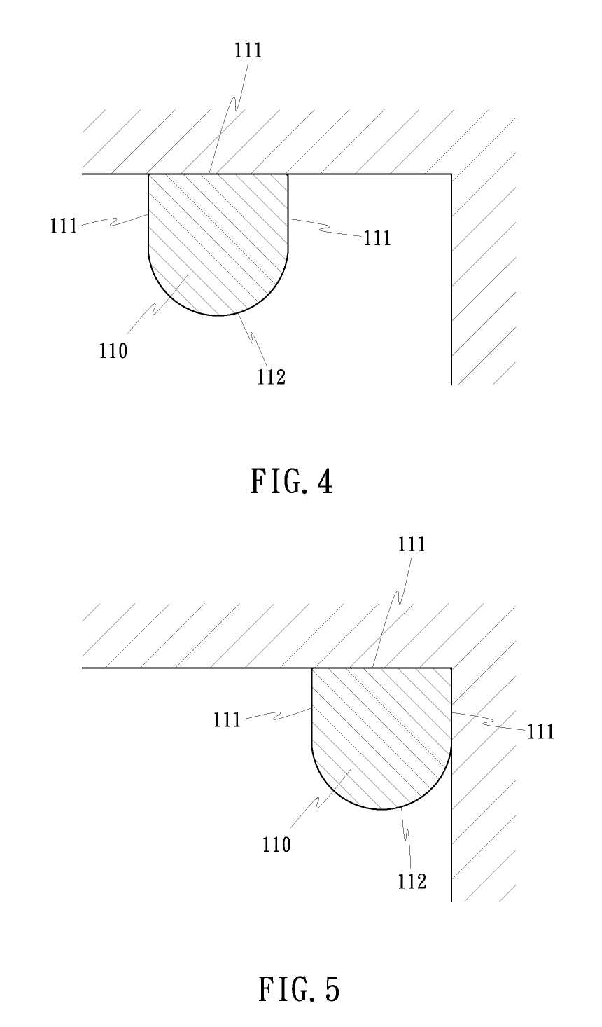

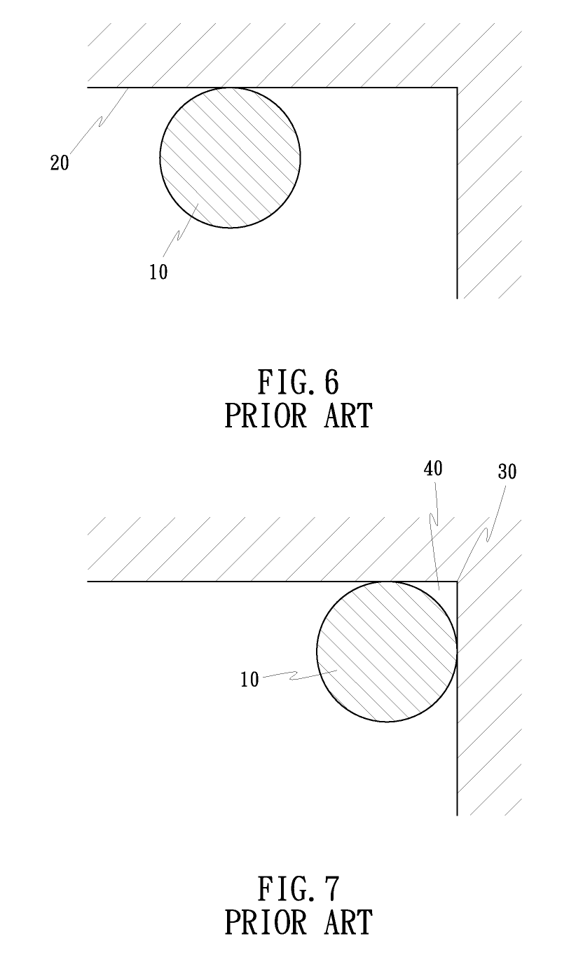

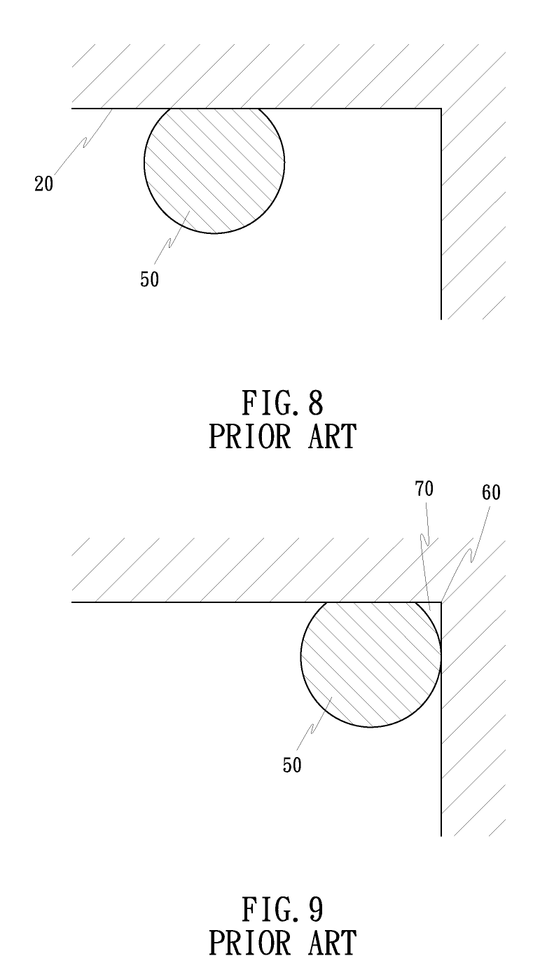

Because the D-shaped impact face 110 of the invention has three straight sides 111 and one arc-shaped side 112, the impact face 110 of the hammerhead 11 is comparatively larger than the impact face of a conventional hammer that is shaped like the letter “O”, when both have the same width and height. Utilizing straight sides 111 for three of its sides allows the impact face 110 to encompass the intersection area at the corner (as shown in FIG. 3) when it is used to carry out hammering actions at corners between two walls or other similar locations. Therefore, whether the impact face of the invention is used to hammer on a single wall, corners between two walls, or other similar locations (as shown in FIG. 4 and FIG. 5), the point at which force is applied can be precisely controlled and consequently dead spots during hammering can be reached, thereby allowing one to make full use of hammers. As a result, the hammer of the invention can achieve hammering even within the dead spots, and this allows users to deal with all kinds of problems they might encounter during hammering.

In the hammerhead 11 of said hammer 1, a blade portion 113 extends from the other end of the hammerhead 11, and a V-shaped trough 114 is formed at one side of the blade portion 113. Moreover, the two lateral sides in the main body of the hammerhead 11 are formed with a flat portion 115 for sideways hammering action, respectively; the two flat portions 115 at both lateral sides are covered with adequate rough surface; a handle 12 is also assembled onto the hammerhead 11 to form a handheld hammer 1.

In summary, the hammer structure according to the preferred embodiment of the invention, with its overall assemblage and applications, is a novel structure that did not appear before; it can reach any dead spots that may be encountered during hammering, thus allowing hammering actions to be carried out despite the dead spots.

The embodiments disclosed in the paragraphs above only serve the purpose of elucidation, and are not to be used to limit the scope of the invention in any ways; any applications with similar structure that produces identical effects, or any variations derived therefrom, are viewed as within the scope of the invention.

What is claimed is:

1. A hammer structure, comprising a hammerhead having an impact face which has three straight sides and one arc-shaped side, wherein one of the three straight sides is connected to and perpendicular to the other two straight sides, which are connected to the arc-shaped side, thus making the impact face of the hammerhead appear to be in the shape of the letter “D”.

2. The hammer structure of claim 1, wherein the three straight sides are a top side and two lateral sides of the impact face, and the arc-shaped side is a bottom side thereof, wherein the top side is the side farthest from a free end of a handle when the handle is attached to the hammerhead.

3. The hammer structure of claim 1, wherein the hammerhead has a blade portion extending from an end of the hammerhead opposite to the impact face; and a V-shaped trough is formed at one side of said blade portion.

4. The hammer structure of claim 1, wherein the hammerhead has a main body with two lateral sides, each of which is formed with a flat portion for sideways hammering action.

5. The hammer structure of claim 1, wherein the impact face of the hammerhead has a rough surface.
